(19) United States
(12) Patent Application Publication
(10) Pub. No.: US 2018/0186039 A1
(43) Pub. Date: Jul. 5, 2018

(54) IN-LINE BLOW MOLD CLEANING DEVICE AND METHOD OF USE

(71) Applicant: Graham Packaging Company, L.P., Lancaster, PA (US)

(72) Inventors: Dustin J. Craig, Bradford, PA (US); Clarence Fields, Atlanta, GA (US); Ryan Smith, Harrisburg, PA (US); Brant Meier, Lakeland, FL (US); Kevin Kotal, Mulberry, FL (US); Brian Herrera, Bartow, FL (US); Tyler Stagner, Lakeland, FL (US)

(73) Assignee: Graham Packaging Company, L.P., Lancaster, PA (US)

(21) Appl. No.: 15/393,448

(22) Filed: Dec. 29, 2016

(51) Int. Cl. B29C 33/72; B29C 49/42; B29C 49/12

(52) U.S. Cl. CPC B29C 33/72; B29C 49/4268; B29L 2031/7158; B29C 2033/727; B29C 49/12

(57) ABSTRACT

A mold cleaner for in-line cleaning of a mold cavity of a blow mold of a blow molding machine. The cleaner has a mount attaching the cleaner to the collet of the machine, enabling the feed belt of the machine to transport the collet and the cleaner to and from the blow mold to be cleaned. An air-powered motor engages the mount, has a motor shaft, and receives air from the blow seal of the machine, which activates the motor and rotates the motor shaft. A bearing carrier surrounds the motor and engages the mount. A cleaning unit is carried by the bearing carrier and rotated by the motor shaft, and contacts the mold cavity to clean the mold cavity. A related method is also provided of using the mold cleaner to perform in-line cleaning of a mold cavity of a blow mold of a blow molding machine.

### TECHNICAL FIELD

The present invention relates generally to the blow molding of plastic articles, such as containers and the like, and, more particularly, to a device and method for cleaning the molds in-line following the production of the plastic articles.

### BACKGROUND OF THE INVENTION

Blow molding processes for forming plastic (e.g., polyethylene terephthalate (“PET”)) articles are well known in the art. To form a plastic article by blow molding, a plastic preform is first inserted into a blow mold. The blow mold has walls defining a mold cavity that corresponds with the shape of the finished article. The blow mold is heated to a desired temperature at which the material of the preform stretches. The preform may alternatively be heated to the desired temperature before it is inserted into the blow mold. Typically, the blow mold includes two halves which close around the preform. An elongated stretch blow rod is then inserted into the preform and high pressure air is injected into the preform, causing the preform to expand against the walls of the blow mold to form the finished article. The blow mold then may be opened and the finished article removed.

Certain blow molding processes, such as the process disclosed in U.S. Pat. No. 9,023,446 (incorporated herein by reference), operate at high temperatures in order to impart desirable characteristics to the plastic article. Enhanced thermal properties are among those characteristics. One drawback of the high-temperature process is buildup of melted resin from the preform on the walls of the blow mold. Over time, the buildup of resin results in decreased clarity of the plastic articles made in the dirty molds. This problem necessitates regular cleaning, for example every 48-72 hours depending on the frequency of use.

Presently, the process of cleaning the blow molds requires removing the molds from the blow molding machine and manually scrubbing the melted resin from the walls. This process is cumbersome, labor-intensive, and time-consuming, and significantly increases both the overall downtime of the machine and the likelihood of damage to the blow molds. Accordingly, there exists a need for a more efficient process for cleaning blow molds that does not require removal of the molds from the blow molding machine.

### SUMMARY OF THE INVENTION

To meet this and other needs, to overcome the shortcomings of existing processes for cleaning blow molds, and in view of their purposes, an improved mold cleaner and a related method of using the mold cleaner are provided. An object of the mold cleaner and the related method is to engage and use the current blow molding machine functions and utilities. Related objects are to attach the mold cleaner to the blow molding machine using the existing collet of that machine, and to use the existing feed belt of the blow molding machine to position the mold cleaner within the blow mold to be cleaned. Another related object is to use the existing air of the blow molding machine to activate the mold cleaner and enable the mold cleaner to perform its cleaning function. It is still another related object to allow for “hands on” operator control of the cleaning method using the blow molding machine itself.

Other objects are to allow the mold cleaner to perform a variety of functions during the cleaning process (e.g., wet clean and dry wipe) and to work with a variety of blow molds. A further object is to reduce the time now required to clean blow molds. A still further object is to eliminate water leaks, heater malfunctions, pinched wires, and wear caused by removing the blow molds from the blow molding machine. Still other objects are to minimize (a) the risk of damage during removal of the blow molds, as occurs during the conventional cleaning process; and (b) safety concerns related to moving the relatively heavy blow molds. An additional object is to permit inspection of the mold cleaner between cycles of use, allowing identification of wear and breakage of components (and replacement of components as needed) and application of cleaning solvents and other materials. Yet another object is to allow the user to switch between mold cleaners having different functions (e.g., polish and wipe) and configurations.

The mold cleaner provides in-line cleaning of the mold cavity of the blow mold of the blow molding machine. The blow molding machine has a collet attached to a moving feed belt, which transports the collet to and from the blow mold, and a blow rod surrounded by a blow seal which provides air to blow a preform into an article within the blow mold. The mold cleaner has a mount adapted to attach the mold cleaner to the collet, enabling the feed belt of the blow molding machine to transport the collet and the mold cleaner to and from the blow mold to be cleaned. An air-powered motor of the mold cleaner engages the mount, has a motor shaft, and receives air from the blow seal (or, alternatively, from the blow rod), which activates the motor and rotates the motor shaft. A bearing carrier surrounds the air-powered motor and engages the mount. A cleaning unit is carried by the bearing carrier and rotated by the motor shaft, and contacts the mold cavity of the blow mold so that the cleaning unit cleans the mold cavity.

The related method uses the mold cleaner described above to perform in-line cleaning of the mold cavity. The method comprising several steps. First, the mold cleaner is provided. The operation of the blow molding machine is stopped, with the blow mold open, and the mold cleaner is affixed to the collet of the blow molding machine. The blow molding machine is operated to move the feed belt and, therefore, the collet and place the mold cleaner into the mold cavity of the blow mold. The blow mold is closed. The blow molding machine is operated to lower the blow seal into contact with the collet and deliver air through the collet and to the mold cleaner, the air activating the air-powered motor of the mold cleaner, thereby rotating the cleaning unit of the mold cleaner and causing the mold cleaner to clean the walls of the mold cavity of the blow mold. The blow molding machine is operated to stop the flow of air, remove the blow seal from the collet, and open the blow mold. Finally, the mold cleaner is cycled out of the blow mold and away from the blow molding machine.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a side elevation view showing a preform overlaid onto a mold cavity of a blow molding machine for a jar-type container;

FIG. 2 is a side elevation view of a mold cavity having six zones of temperature control;

FIG. 3 is a side elevation view in cross section of a blow mold having a blow rod providing recirculating air to an inner surface of the container being formed;

FIG. 4A is a cross-sectional view illustrating a blow seal and a blow rod of a blow molding machine in a raised position above a collet of the blow molding machine;

FIG. 4B is a cross-sectional view illustrating the blow seal and the blow rod of the blow molding machine in a lowered position with the blow seal in contact with the collet of the blow molding machine shown in FIG. 4A;

FIG. 5 is an exploded view of a mold cleaner according to an embodiment of the present invention;

FIG. 6 highlights the cleaning unit, one component of the mold cleaner shown in FIG. 5;

FIG. 7 illustrates the contoured outer edges of the mold cleaner shown in FIG. 5;

FIG. 8 is a perspective view of a blow molding machine collet;

FIG. 9A is a perspective view of a suitable tool that can be used to attach the mount (and, in turn, the rest of the components that comprise the mold cleaner) of the mold cleaner to a collet;

FIG. 9B is an end view of the tool shown in FIG. 9A;

FIG. 9C is a side view of the tool shown in FIGS. 9A and 9B;

FIG. 10 illustrates a plurality of mold cleaners, attached to respective collets which, in turn, are affixed to the feed belt of a blow molding machine in a staging area proximate to the blow molding machine; and

FIG. 11 highlights the holding plate shown in FIG. 10.

### DETAILED DESCRIPTION

A mold cleaner and methods of using the mold cleaner are provided to improve the functioning of a blow molding machine. Blow molding machines are used to form an article such as a container or the like. The exemplary container is made of a polyester resin such as, for example, poly(ethylene)terephthalate (PET), having enhanced thermal properties while still providing a container with high clarity. Suitable polyester resins include, for example, homopolymers of poly(ethylene)-phthalate, copolymers of poly(ethylene)terephthalate, poly(ethylene)isophthalate, poly(ethylene)naphthalate, poly(dimethylene)terephthalate, and poly(butylene)terephthalate. In preferred embodiments, the containers comprise PET. Preferably, the PET has an intrinsic viscosity of from about 0.72 dL/g to about 0.86 dL/g. Suitable PET resins include bottle-grade PET resins such as, for example, any of the PARASTAR® resins sold by the Eastman Chemical Company, and CLEAR TUF® resins sold by M&G Polymers.

The PET containers can have any geometry, shape, or size. For example, PET containers can be round, oval, polygonal, and irregular. Suitable containers can be a jar-type, can-type, carafe, wide mouth, and any other type container known to those of ordinary skill in the art. Suitable features of the containers can include pressure-absorbing features, grip-enhancing features, shoulders, bumpers, finishes, chimes, standing rings, necks, and others known to those of ordinary skill in the art.

Referring now to the drawing, in which like reference numbers refer to like elements throughout the various figures that comprise the drawing, embodiments of the present invention include devices and methods for in-line cleaning of blow molds.

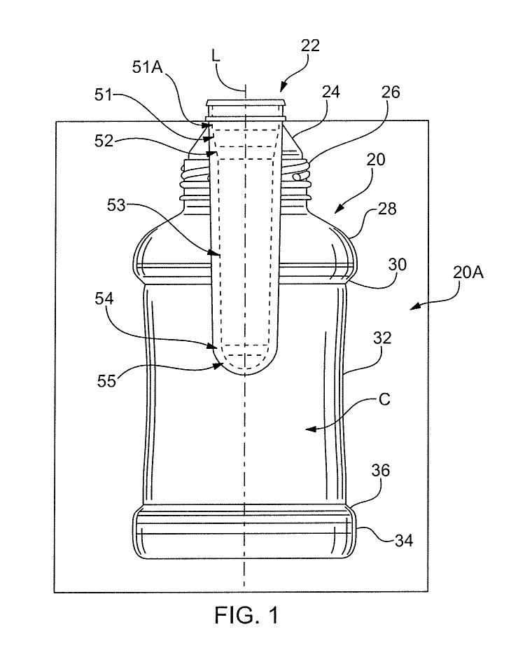

Shown in FIG. 1 is an exemplary embodiment of a preform 22 having distinctive zones each of which corresponds to a distinct area of the finished container C. In the embodiment shown in FIG. 1, the preform 22 is disposed along a longitudinal axis L and has six distinct zones. Zone 51A is a top-forming region forming the conical top 24 of the container C. Zone 51 is a finish-forming region forming the neck finish 26 of the container C. Zone 52 is a shoulder-forming region forming the shoulder 28, having an underside 30, of the container C. Zone 53 is a barrel-forming region forming the barrel section 32 of the container C. Zone 54 is a heel-forming region forming the heel 36 of the container C. And zone 55 is a base-forming region forming the base 34 of the container C. The preform 22 is amorphous in that the PET polymer chains typically do not form lamellae, globules, or any other known molecular organization and, therefore, do not have a substantial amount of crystalline regions, if any exist at all.

The preform 22 is typically injection molded. Then the molded preform 22, while still hot, is transported to at least one conditioning station, preferably within 10 seconds after completion of injection molding. The preform 22 is “conditioned” by modifying the temperature of select portions of the preform 22. Next, the conditioned preform 22 is transported to a blow mold 20A, preferably within about 10 seconds after the final conditioning is completed, to expand the preform into a container C via a blow molding process. The blow molding process includes the steps of inserting the preform 22 into a blow mold 20A having two halves, locking the blow mold halves, and blowing air into the preform to biaxially stretch the PET into the container shape defined by the blow mold 20A.

As shown in FIG. 1, the preform 22 is disposed within a blow mold cavity 20 of the blow mold 20A in which the temperature of the blow mold 20A is higher than the glass transition temperature (“Tg”) of PET. Preferably, the temperature of the blow mold 20A is between from about 73° C. to about 250° C., more preferably between from about 150° C. to about 240° C., still more preferably between from about 160° C. to about 230° C., and most preferably between from about 160° C. to about 200° C. The wall of the blow mold 20A defines the blow mold cavity 20 having a volume for receiving the PET preform 22 from the injection molding station and blowing the preform 22 into an expanded PET container C against the wall of the blow mold cavity 20.

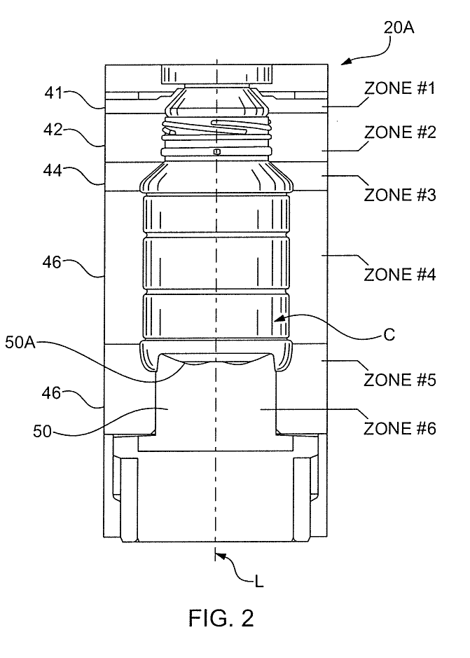

In a preferred embodiment shown in FIG. 2, the blow mold 20A has several zones of thermal control along the longitudinal axis L of the blow mold 20A. The temperature of each zone can be independently set and controlled. FIG. 2 shows one example of a multi-zone blow mold 20A defining the mold cavity 20 having six zones that will maintain temperatures in the thinner wall sections at higher temperatures than in the thicker wall sections. For example zone 1 (reference number 41) for forming the conical top 24 of the container C will typically be maintained within the range of about 73° C. to about 120° C. Zone 2 (reference number 42) corresponding to the neck finish 26 will typically be maintained within the range of about 160° C. to about 240° C. Zones 3 and 5 (reference numbers 44 and 48) corresponding respectively to the shoulder 28 and the base 34 will typically be maintained within the range of about 150° C. to about 230° C. Zone 4 (reference number 46) corresponding to the barrel section 32 will typically be maintained within the range of about 190° C. to about 250° C. Zone 6 corresponding to the bottom 50 of the container C will typically be maintained within the range of about 100° C. to about 230° C. The bottom 50 includes a molding surface 50A for forming a bottom portion of the container C and, optionally, a pressure-absorbing panel. Although the blow mold 20A of FIG. 2 shows six zones of temperature control, a fewer or greater number of zones—including from three to eight or more separate zones of temperature control—may be provided.

In preferred embodiments of the present invention, the container C is cooled before it is ejected from the blow mold 20A. To cool the container C, cooling fluid may be directed onto an inner surface of the sidewall of the blow mold 20A and/or directly into the container C. The cooling fluid can be a liquid or a gas but more preferably is a gas. Suitable gasses include air, nitrogen, and other gasses known to those of ordinary skill in the art. In especially preferred embodiments, the blow mold 20A can selectively cool predetermined portions of the inner surface of a freshly blown (i.e., heated) container C by directing a flow of cooling fluid with the thicker wall portions receiving more cooling fluid than the thinner wall portions as the container C has a sidewall having varying thicknesses along an axial dimension of the container C with thinner wall portions and thicker wall portions. (By “predetermined” is meant determined beforehand, so that the predetermined characteristic must be determined, i.e., chosen or at least known, in advance of some event.)

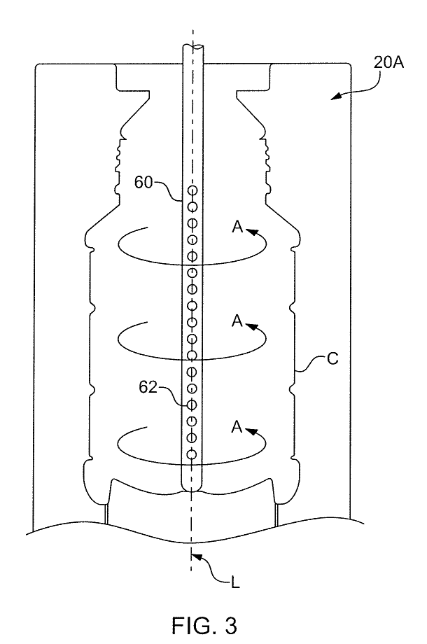

For example, referring now to FIG. 3, the cooling fluid is air and is directed to the inner surface of the container C using a blow rod 60 having air holes 62. The air is preferably at a temperature of less than about 50° C., and more preferably within the range of about 20° C. to about 50° C., and under a pressure from about 290 psi (2 MPa) to about 580 psi (4 MPa) for a time from about two seconds to about six seconds. Air holes 62 will have varying area dimensions to provide greater amounts of cooling air to the thicker wall portions and less cooling air to the thinner wall portions of the container C. The blow rod 60 can be rotated around the longitudinal axis L in the direction of arrows A.

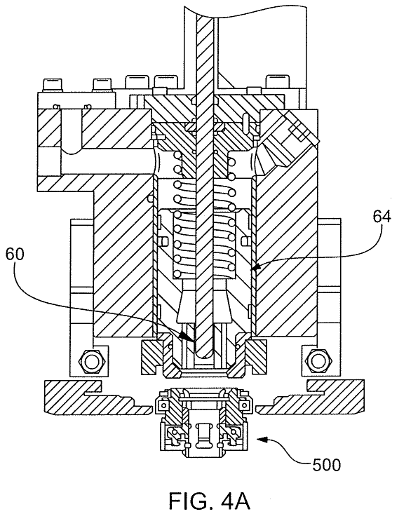

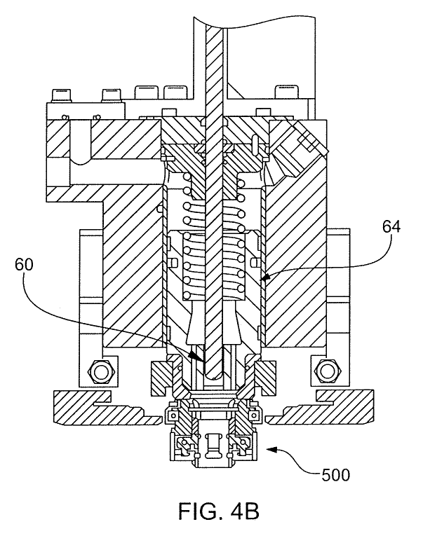

As shown in FIG. 4A, the blow molding machine has a blow seal 64 as well as the blow rod 60. FIG. 4A illustrates the blow rod 60 and the blow seal 64 in a raised position above a collet 500 of the blow molding machine. FIG. 4B illustrates the blow seal 64 and the blow rod 60 of the blow molding machine in a lowered position with the blow seal 64 in contact with the collet 500 of the blow molding machine. When in the lowered position, the blow seal 64 creates a surface-to-surface seal against the top of the collet 500.

As discussed above, the process of using a blow molding machine to foul′ the container C requires very high processing temperatures. It has been discovered that such high processing temperatures cause plastic to build up on the face of the blow molds 20A—especially for certain resin types. Such plastic build up adversely affects the clarity of the containers C produced. To maintain the requisite clarity of the container C, the blow molding machine must be stopped and the blow molds 20A must be pulled every 48-72 hours so that the blow molds 20A can be cleaned by hand. This cleaning process takes about 5 hours, is cumbersome, reduces the cost effectiveness of plant operation, and slows container production. In addition, the blow molds 20A are relatively heavy and, therefore, pose safety risks when being handled and cleaned.

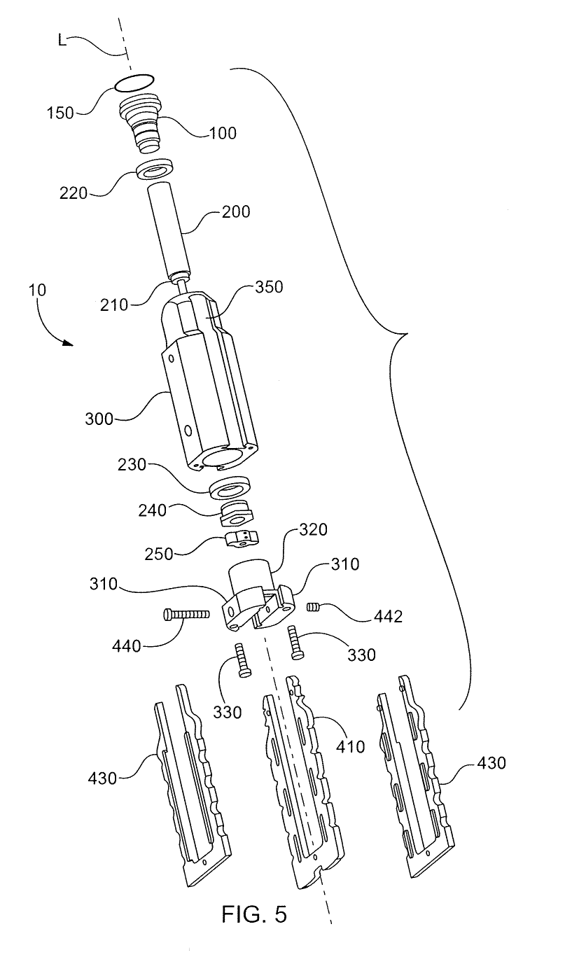

Referring to FIG. 5, an exemplary mold cleaner 10 is illustrated for use in connection with a blow molding machine having the blow mold 20A. A main purpose of the mold cleaner 10 is to improve the functioning of the blow mold 20A and, therefore, of the blow molding machine. The mold cleaner 10 generally includes a mount 100, an air-powered motor 200, a bearing carrier 300, and a cleaning unit 400.

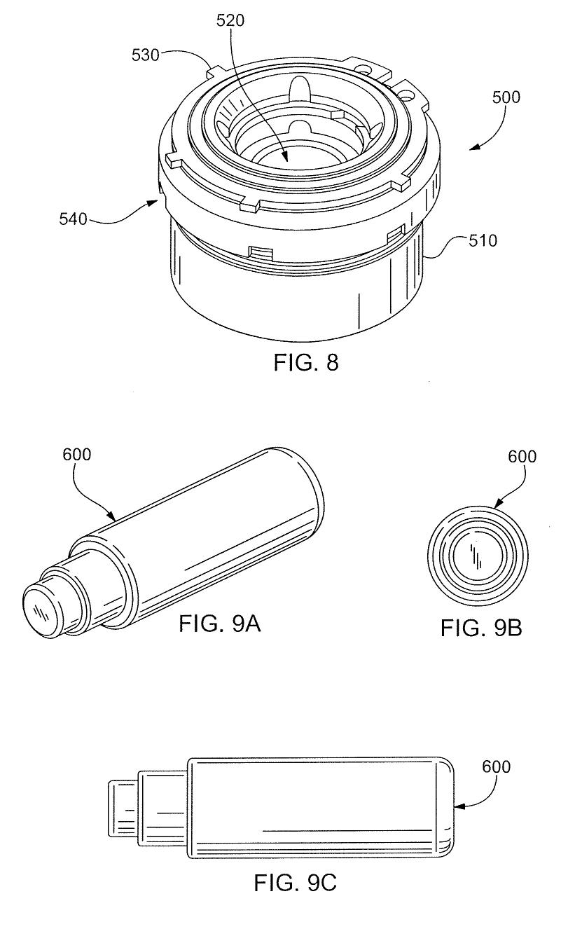

The mount 100 engages the standard collet 500 (see FIG. 8) that delivers the preform 22 from the injection cavity to the mold cavities 20 of the blow mold 20A. The engagement between the mount 100 and the collet 500 is facilitated by an O-ring 150. On its end opposite the collet 500, the mount 100 engages the air-powered motor 200.

In the exemplary embodiment illustrated, the air-powered motor 200 includes a motor shaft 210, a top bearing 220, a bottom bearing 230, a bearing nut 240, and a drive star 250. The top bearing 220 facilitates engagement between the mount 100 and the bearing carrier 300; the top bearing 220 is held in position against the contours of the mount 100. The air-powered motor 200 has a longitudinal body from which the rotating motor shaft 210 extends. The air-powered motor 200 receives air from the blow molding machine, which is alternatively used to blow the preform 22, and uses that air to rotate the motor shaft 210 about the longitudinal axis L. A suitable air-powered motor 200 is similar to that of an air-powered die grinder with high torque at lower speeds (RPMs).

Located proximate the end of the air-powered motor 200 opposite the top bearing 220, the bottom bearing 230 is held in position within the bearing carrier 300 by the bearing nut 240. The motor shaft 210 passes through the respective centers of the bottom bearing 230 and the bearing nut 240 and engages the drive star 250. Thus, the motor shaft 210 rotates the drive star 250 as the motor shaft 210 rotates.

In turn, the drive star 250 engages and rotates a drive body 320. The bearing carrier 300 surrounds and encloses the air-powered motor 200 and, in part, the drive body 320. The drive body 320 has a pair of flanges 310 each having a plurality of longitudinal holes and perpendicular (i.e., lateral) openings. The drive body 320 is affixed to the bearing carrier 300 by fasteners (e.g., bolts 330) that are positioned through the holes of the flanges 310 of the drive body 320 and engage corresponding longitudinal apertures located in the bearing carrier 300. Although a variety of materials are suitable, the drive body 320 and the bearing carrier 300 are preferably each constructed of rigid plastic having a relatively high melting temperature.

The cleaning unit 400 includes a central, preferably U-shaped wiper 410 sandwiched between a pair of preferably U-shaped wiper plates 430. The wiper 410 is preferably a flexible component such as a felt pad. The wiper plates 430 support and provide rigidity to the wiper 410. Each of the wiper 410 and the wiper plates 430 have substantially the same U-shape.

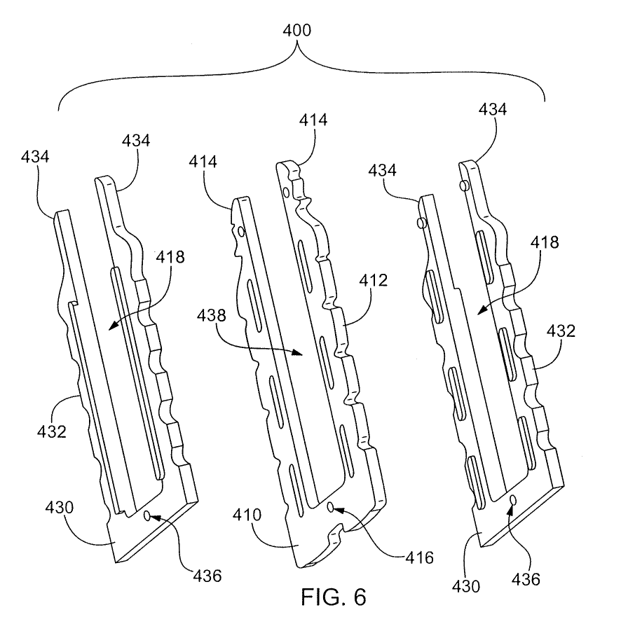

The cleaning unit 400 is highlighted in FIG. 6. The legs 414 of the U-shaped wiper 410 and the legs 434 of the wiper plates 430 pass through the spaces between the flanges 310 of the drive body 320, and the inside portions of the legs 414 of the U-shaped wiper 410 and the inside portions of the legs 434 of the wiper plates 430 engage longitudinal slots 350 in the bearing carrier 300. The legs 414 of the U-shaped wiper 410 are separated by, and define, a center orifice 438 and the legs 434 of the U-shaped wiper plates 430 are separated by, and define, a center orifice 418. The wiper 410 and wiper plates 430 are releasably affixed to the drive body 320 (and, therefore, to the bearing carrier 300) by a fastener (e.g., a screw 440) that is positioned through the lateral openings of the flanges 310 of the drive body 320 and engages a corresponding lateral aperture 416 located in the wiper 410 and lateral apertures 436 located in the wiper plates 430. A tapping insert 442 is also provided to releasably affix the wiper 410 and the wiper plates 430 to the drive body 320. Thus, the wiper 400 and the wiper plates 430 rotate along with the bearing carrier 300 and the drive body 320. It is important that the wiper 410 and the wiper plates 430 be releasable so that the wiper 410 can be replaced and interchanged with other wipers 410 easily, enabling the mold cleaner 10 to clean a variety and large number of blow molds 20A.

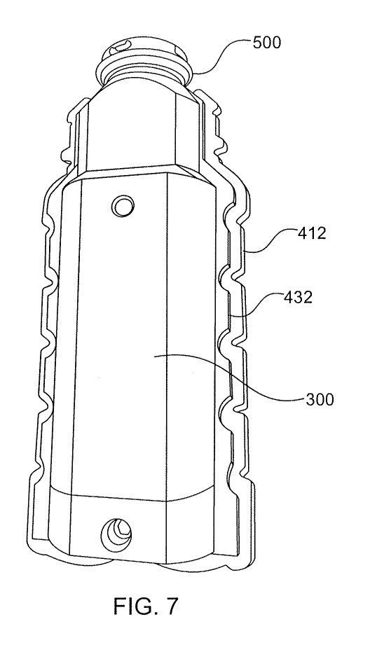

Each of the wiper 410 and the wiper plates 430 include contoured outer edges 412 and 432, respectively. As illustrated in FIG. 7, the contoured outer edge 412 of the wiper 410 extends laterally beyond the contoured outer edges 432 of the wiper plates 430. Such a configuration allows the contoured outer edge 412 of the wiper 410, supported by the contoured outer edges 432 of the wiper plates 430, to contact the inside surfaces of the mold cavity 20 of the blow mold 20A. The contoured outer edges 412 and 432 correspond (i.e., are shaped and sized) both with each other and with the contours of the inside surfaces of the mold cavity 20. The mold cleaner 10 is spring loaded and can expand under centrifugal force to assure that the contoured outer edge 412 contacts the inside surfaces of the mold cavity 20.

Turning to FIG. 8, the collet 500 has an approximately cylindrical hollow body 510 surrounding a central bore 520. The cylindrical hollow body 510 further includes a plurality of clips 530 and recesses 540 used to attach the collet 500 to the feed belt 700 of a blow molding machine. The precise configuration of the clips 530 and recesses 540 will be dependent on the specific blow molding machine with which the collet 500 is used. In some embodiments, the collet 500 is standard to the specific blow molding machine and is typically attached to the plastic preform 22 to be blown into a hollow plastic article (e.g., the container C) by the blow molding machine. Instead of the plastic preform 22, the mount 100 is attached to the collet 500, as described below.

A tool 600 is used to attach the mount 100 (and, in turn, the rest of the components that comprise the mold cleaner 10) to the collet 500. FIG. 9A is a perspective view of the tool 600; FIG. 9B is an end view of the tool 600; and FIG. 9C is a side view of the tool 600. The tool 600 is preferably a hand-held tool, but any suitable tool 600 can be used—as would be within the knowledge of a person of ordinary skill in the art. The tool 600 positions the mold cleaner 10 within the collet 500. The collet 500 is affixed to the feed belt 700 of the blow molding machine and held stationary on the feed belt 700; therefore, the collet 500 cannot rotate. Thus, once the mold cleaner 10 engages and is attached to the collet 500, the mold cleaner 10 is affixed to the feed belt 700. The air-powered motor 200 of the mold cleaner 10 rotates independently of the collet 500. Rotation of the mold cleaner 10 is created with an impeller and ball screw shaft assembly using the blow air of the blow molding machine. Of course, rather than the tool 600, an automated mechanism could be used to attach the mold cleaner 10 to the collet 500.

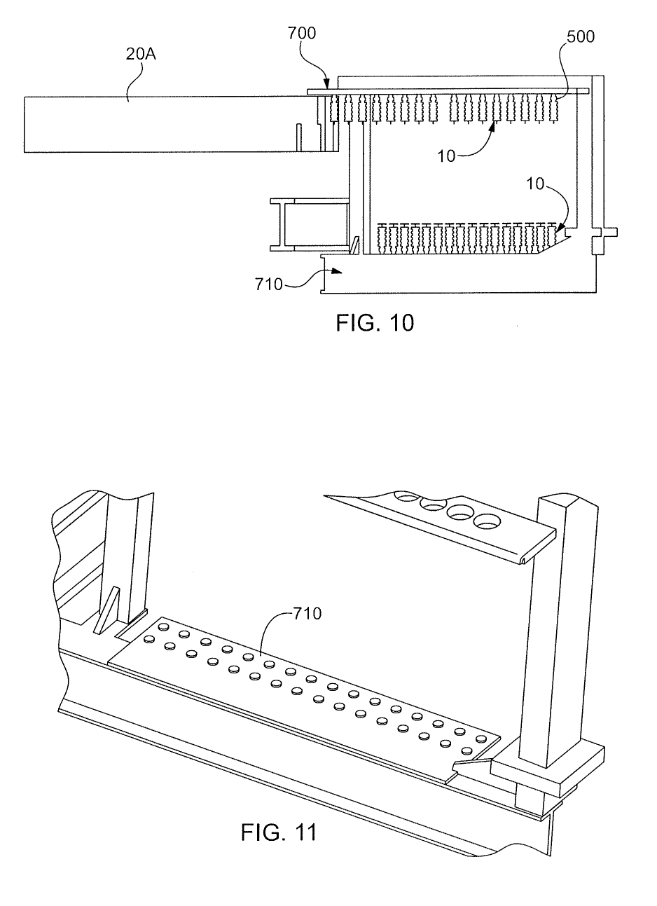

FIG. 10 illustrates a plurality of mold cleaners 10, attached to respective collets 500 which, in turn, are affixed to the feed belt 700. While awaiting attachment to their respective collets 500, the mold cleaners 10 can be stored (as shown) on a holding plate 710. The holding plate 710 is located in a staging area proximate to the blow molding machine, which includes the blow molds 20A. The holding plate 710 is highlighted in FIG. 11. Thus, the mold cleaners 10 operate in-line with the blow molding machine.

Once the mold cleaners 10 are attached to the feed belt 700, the mold cleaners 10 are cycled into the mold cavities 20 of the blow molds 20A of the blow molding machine. The blow molds 20A are closed, and the blow molding machine is operated to cycle the blow seals 64 into position. This position interfaces the blow seals 64 with the fixed collets 500. At this point the air of the blow molding machine is turned on, at approximately 120 to 150 psi (0.827 to 1.03 MPa), and delivered through the blow seals 94 and the collets 500 to the mold cleaners 10. Thus delivered, the air operates the mold cleaners 10. More specifically, the air powers the air-powered motor 200 of each mold cleaner 10. The air-powered motors 200 of the mold cleaners 10 cause the cleaning units 400 to rotate or spin inside of the mold cavity 20 of each blow mold 20A, thereby cleaning the mold cavities 20.

An exemplary method of using the mold cleaner 10 includes at least the following steps. First, a suitable cleaning unit 400 (including the wiper 410 and corresponding wiper plates 430) is selected. The contoured outer edges 412 of the wiper 410 and the contoured outer edges 432 of the wiper plates 430 must correspond (i.e., be shaped and sized) both with each other and with the contours of the inside surfaces of the mold cavity 20 to be cleaned. Then the cleaning unit 400 is attached to the bearing carrier 300 to form a complete mold cleaner 10. If desired, as an optional next step, a cleaning solvent can be applied to the wiper 410 to enhance the cleaning action of the mold cleaner 10.

The exemplary method continues by stopping the operation of the blow molding machine (with the blow molds 20A open) and affixing the mold cleaner 10 to the collet 500 of the blow molding machine. The collet 500 typically is attached to, and depends from, the feed belt 700 of the blow molding machine. The step of affixing the mold cleaner 10 to the collet 500 can be facilitated by using the tool 600. The blow molding machine then is operated, in its normal manner, to move the feed belt 700 (and, therefore, the collet 500) and place the mold cleaner 10 into the mold cavity 20 of a blow mold 20A. Next, the blow mold 20A is closed.

Also operating the blow molding machine in its normal manner, the blow seal 64 is placed into contact with the collet 500 and air is delivered through the blow seal 64 and the collet 500 to the mold cleaner 10. The air activates the air-powered motor 200 of the mold cleaner 10, thereby rotating the cleaning unit 400 of the mold cleaner 10. Such rotation causes the mold cleaner 10 to clean the walls of the mold cavity 20 of the blow mold 20A. Finally, and again operating the blow molding machine in its normal manner, the blow seal 64 is raised above the collet 500, the blow mold 20A is opened, and the mold cleaner 10 is cycled out of the blow mold 20A and away from the blow molding machine. Optionally, a blow cycle can be completed, in which the blow seal 64 is placed back into contact with the collet 500 and air is delivered through the blow seal 64 and the collet 500 to the open and now empty blow mold 20A. The air passes into and through the blow mold 20A, thereby pushing the cleaning debris (such as fines) out of the blow mold 20A.

Once the mold cleaner 10 is external to the blow molding machine, cleaning solvent can be applied or re-applied to the wiper 410, one or both of the wiper 410 and the wiper plates 430 can be replaced, and other operations can be performed on the mold cleaner 10. The above steps of the method can then be repeated as desired. In an exemplary method, two separate mold cleaners 10 are used, one to polish or clean the blow mold 20A using a solvent and another to wipe dry the blow mold 20A, then a blow cycle is used to clear the fines.

### EXAMPLES

The following test examples are included to more clearly demonstrate the overall nature of the invention. These examples are exemplary, not restrictive, of the invention. They result from tests completed in the Bradford, Pa. plant of the assignee of the present application, Graham Packaging Company, L.P. The specifications of the air-powered motor 200 used in the tests were: 622 rpm at about 140 psi (0.965 MPa), with a start torque of about 25 pounds-force inch (2.8 newton meters), and a horsepower of about 0.127 (94.7 watts or joules per second) at 400 rpm.

In Test 1, the mold cleaner 10 was cycled into one of sixteen blow molds 20A of a blow molding machine. The wiper 410 was dry with no cleaning agent applied. The mold cleaner 10 was engaged for 120 seconds and 1,244 revolutions. The blow mold 20A was then inspected for cleanness, and observed to be about 65% clean.

In Test 2, a food-grade mineral spirit was applied to the wiper 410 of the mold cleaner 10. The mold cleaner 10 was cycled into another one of the sixteen blow molds 20A. The mold cleaner 10 was engaged for 120 seconds and 1,244 revolutions. The blow mold 20A was then inspected for cleanness, and observed to be about 90% clean. A suitable food-grade mineral spirit is available from JAX, Inc. of Menomonee Falls, Wis.

In Test 3, a food-grade mineral spirit was again applied to the wiper 410 of the mold cleaner 10. The mold cleaner 10 was cycled into yet another one of the sixteen blow molds 20A. The mold cleaner 10 was engaged, this time for 240 seconds and 2,488 revolutions. The blow mold 20A was then inspected for cleanness, and again observed to be about 90% clean. After cycling the mold cleaner 10 out of the blow mold 20A of the blow molding machine, it was noticed that the wiper 410 was dry. There was no real improvement seen with the duration increase.

In Test 4, a food-grade mineral spirit was again applied to the wiper 410 of the mold cleaner 10. The mold cleaner 10 was cycled into still another one of the sixteen blow molds 20A. The mold cleaner 10 was engaged for 120 seconds and 1,244 revolutions. The mold cleaner 10 was then cycled out of the blow molding machine and the food-grade mineral spirit was re-applied to the wiper 410 and cycled back into the blow molding machine. The mold cleaner 10 was re-engaged for an additional 120 seconds and 1,244 revolutions. The blow mold 20A was then inspected for cleanness, and observed to be about 99% clean.

Table I summarizes the four tests.

TABLE I

| | | | Result -- Clean |
|---|---|---|---|
| Test No. | Duration (seconds) | Cleaning Agent? | Observation (%) |
| 1 | 120 | No | 65 |
| 2 | 120 | Yes | 90 |
| 3 | 240 | Yes | 90 |
| 4 | 120 + 120 = 240 | Yes + Yes | 99 |

In summary, Test 1 (the mold cleaner 10 was engaged for 120 seconds without cleaning agent) did some cleaning. Tests 2 and 3 (the mold cleaner 10 was engaged for 120 seconds and 240 seconds, respectively) showed that the addition of cleaning agent significantly improved the cleaning results. Test 4 showed that the blow mold 20A was substantially (i.e., almost completely) clean after the mold cleaner 10 was engaged for 120 seconds using a cleaning agent, the cleaning agent was re-applied, and the mold cleaner 10 was re-engaged for a second cycle of 120 seconds. Thus, although all of the test examples improved cleaning of the blow mold 20A, Test 4 achieved the best results.

Finally, all sixteen blow molds 20A were cleaned using the test parameters from Test 4. After being formed in the blow molds 20A, containers C were pulled right before shut down (dirty blow molds 20A) and then again on startup (clean blow molds 20A) and compared. There was a significant increase in the clarity of the containers C.

The advantages of the mold cleaner 10 and of the related method of using the mold cleaner 10 are many. At least some of those advantages are discussed above. In summary, the mold cleaner 10 and the related method engage and use the current blow molding machine functions and utilities. The mold cleaner 10 is attached to the blow molding machine using the existing collet 500 of that machine. The existing feed belt 700 of the blow molding machine is used to position the mold cleaner 10 within the blow mold 20A to be cleaned. The existing air of the blow molding machine is used to activate the air-powered motor 200 of the mold cleaner 10, thereby rotating the cleaning unit 400 of the mold cleaner 10 and performing the cleaning function. The mold cleaner 10 and the related method of using the mold cleaner 10 allow for “hands on” operator control of the cleaning method using the blow molding machine itself.

Interchangeable wipers 410 and corresponding wiper plates 430 allow the mold cleaner 10 to perform a variety of functions during the cleaning process (e.g., wet clean and dry wipe) and to work with a variety of blow molds 20A. The mold cleaner 10 and the related method of using the mold cleaner 10 can reduce the time now required to clean blow molds 20A by over five times. They can also eliminate water leaks, heater malfunctions, pinched wires, and wear caused by removing the blow molds 20A. They can further minimize (a) the risk of damage during removal of the blow molds 20A, as occurs during the conventional cleaning process; and (b) safety concerns related to moving the relatively heavy blow molds 20A. Because the mold cleaners 10 can be inspected between cycles, wear and breakage of components can be identified (and components replaced as needed) and cleaning solvents and other materials can be applied. The method also allows the user to switch between mold cleaners 10 having different functions (e.g., polish and wipe) and configurations.

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges. It is also expressly intended that the steps of the methods of using the various devices disclosed above are not restricted to any particular order.

What is claimed:

1. A mold cleaner for in-line cleaning of a mold cavity of a blow mold of a blow molding machine, the machine having a collet attached to a moving feed belt which transports the collet to and from the blow mold, a blow seal, and a blow rod which provides air to blow a preform into an article within the blow mold, the mold cleaner comprising:
a mount adapted to attach the mold cleaner to the collet, enabling the feed belt of the blow molding machine to transport the collet and the mold cleaner to and from the blow mold to be cleaned;
an air-powered motor engaging the mount, having a motor shaft, and being adapted to receive air from the blow seal, which activates the motor and rotates the motor shaft;
a bearing carrier surrounding the air-powered motor and engaging the mount; and
a cleaning unit being carried by the bearing carrier, rotated by the motor shaft, and adapted to contact the mold cavity of the blow mold so that the cleaning unit cleans the mold cavity.

2. The mold cleaner of claim 1, wherein the mount, the air-powered motor, the bearing carrier, and the cleaning unit are all aligned along a longitudinal axis.

3. The mold cleaner of claim 1, wherein the cleaning unit includes a wiper sandwiched between two aligned wiper plates.

4. The mold cleaner of claim 3, wherein the wiper has a contoured outer edge adapted to contact the mold cavity and the wiper plates each have a correspondingly shaped contoured outer edge, the wiper plates supporting and providing rigidity to the wiper.

5. The mold cleaner of claim 4, wherein the contoured outer edge of the wiper extends laterally beyond the contoured outer edges of the wiper plates.

6. The mold cleaner of claim 3, wherein the wiper and the wiper plates are releasably affixed to the bearing carrier.

7. The mold cleaner of claim 6, wherein the wiper and the wiper plates each have substantially the same U-shape, with the wiper and each of the wiper plates having a pair of legs.

8. The mold cleaner of claim 7, further comprising a drive body affixed to the bearing carrier and having a pair of flanges defining spaces between the flanges, wherein the legs of the wiper and the legs of the wiper plates pass through the spaces and engage slots in the bearing carrier.

9. The mold cleaner of claim 3, wherein the wiper is a felt pad adapted to receive a cleaning solvent.

10. The mold cleaner of claim 1 further comprising a drive star rotated by the motor shaft and a drive body affixed to the bearing carrier, the drive star engaging and rotating the drive body and the bearing carrier.

11. A mold cleaner for in-line cleaning of a mold cavity of a blow mold of a blow molding machine, the machine having a collet attached to a moving feed belt which transports the collet to and from the blow mold, a blow seal, and a blow rod which provides air to blow a preform into an article within the blow mold, the mold cleaner comprising:
a mount adapted to attach the mold cleaner to the collet, enabling the feed belt of the blow molding machine to transport the collet and the mold cleaner to and from the blow mold to be cleaned;
an air-powered motor engaging the mount, having a motor shaft, and being adapted to receive air from the blow seal, which activates the motor and rotates the motor shaft;
a bearing carrier surrounding the air-powered motor and engaging the mount;
a drive body affixed to the bearing carrier and having a pair of flanges defining spaces between the flanges; and
a cleaning unit releasably affixed to the drive body and to the bearing carrier and rotated by the motor shaft, the cleaning unit including a wiper sandwiched between two aligned wiper plates, the wiper having a contoured outer edge adapted to contact and clean the mold cavity and the wiper plates each having a correspondingly shaped contoured outer edge, the wiper plates supporting and providing rigidity to the wiper, the contoured outer edge of the wiper extending laterally beyond the contoured outer edges of the wiper plates, wherein the wiper and the wiper plates each have substantially the same U-shape, with the wiper and each of the wiper plates having a pair of legs configured to pass through the spaces defined in the drive body and engage slots in the bearing carrier.

12. The mold cleaner of claim 11, wherein the mount, the air-powered motor, the bearing carrier, the drive body, and the cleaning unit are all aligned along a longitudinal axis.

13. The mold cleaner of claim 11, wherein the wiper is a felt pad adapted to receive a cleaning solvent.

14. The mold cleaner of claim 11 further comprising a drive star rotated by the motor shaft, the drive star engaging and rotating the drive body and the bearing carrier.

15. A method for in-line cleaning of a mold cavity of a blow mold of a blow molding machine, the blow molding machine having a collet attached to a moving feed belt which transports the collet to and from the blow mold, a blow seal, and a blow rod which provides air to blow a preform into an article within the blow mold, the method comprising the steps of:
(a) providing a mold cleaner having a mount adapted to attach the mold cleaner to the collet, enabling the feed belt of the blow molding machine to transport the collet and the mold cleaner to and from the blow mold to be cleaned; an air-powered motor engaging the mount, having a motor shaft, and being adapted to receive air from the blow seal, which activates the motor and rotates the motor shaft; a bearing carrier surrounding the air-powered motor and engaging the mount; and a cleaning unit being carried by the bearing carrier, rotated by the motor shaft, and adapted to contact the mold cavity of the blow mold so that the cleaning unit cleans the mold cavity;
(b) stopping the operation of the blow molding machine with the blow mold open;
(c) affixing the mold cleaner to the collet of the blow molding machine;
(d) operating the blow molding machine to move the feed belt and, therefore, the collet and place the mold cleaner into the mold cavity of the blow mold;
(e) closing the blow mold;
(f) operating the blow molding machine to place the blow seal into contact with the collet and deliver air through the blow seal and the collet to the mold cleaner, the air activating the air-powered motor of the mold cleaner, thereby rotating the cleaning unit of the mold cleaner and causing the mold cleaner to clean the walls of the mold cavity of the blow mold;
(g) operating the blow molding machine to stop the flow of air and remove the blow seal from the collet;
(h) opening the blow mold; and
(i) cycling the mold cleaner out of the blow mold and away from the blow molding machine.

16. The method of claim 15 further comprising the step of applying a cleaning solvent to a wiper of the cleaning unit to enhance the cleaning action of the mold cleaner.

17. The method of claim 15 wherein the step of affixing the mold cleaner to the collet is facilitated by using a tool.

18. The method of claim 15 further comprising the step of completing a blow cycle in which the blow seal is placed back into contact with the collet and air is delivered through the blow seal and the collet to the open and empty blow mold so that the air passes into and through the blow mold, thereby pushing cleaning debris out of the blow mold.

19. The method of claim 15 further comprising the step of replacing a wiper of the cleaning unit.

20. The method of claim 15 further comprising repeating the steps as desired.

21. The method of claim 15 wherein, in step (f), the air-powered motor of the mold cleaner rotates the cleaning unit for a cycle of about 120 seconds in the mold cavity of the blow mold.

22. The method of claim 21 further comprising the step of applying a cleaning solvent to a wiper of the cleaning unit, before operating the blow molding machine in step (f), to enhance the cleaning action of the mold cleaner.

23. The method of claim 22 further comprising the steps of re-applying a cleaning solvent to the wiper of the cleaning unit, after the air-powered motor of the mold cleaner rotates the cleaning unit for a cycle of about 120 seconds in the mold cavity of the blow mold, then rotating the cleaning unit for a second cycle of about 120 seconds in the mold cavity of the blow mold.
